(19) United States
(12) Patent Application Publication
(10) Pub. No.: US 2014/0253553 A1
(43) Pub. Date: Sep. 11, 2014

(54) VISUALIZATION OF THREE-DIMENSIONAL MODELS OF OBJECTS IN TWO-DIMENSIONAL ENVIRONMENT

(71) Applicant: Milos Jovanovic, Portland, OR (US)

(72) Inventor: Milos Jovanovic, Portland, OR (US)

(73) Assignee: SPACEVIEW, INC., Portland, OR (US)

(21) Appl. No.: 14/251,503

(22) Filed: Apr. 11, 2014

Related U.S. Application Data
(63) Continuation-in-part of application No. 13/552,658, filed on Jul. 19, 2012.
(60) Provisional application No. 61/660,730, filed on Jun. 17, 2012.

(51) Int. Cl. G06T 17/20; G06F 3/0484; G06F 3/0488; G06F 3/0481

(52) U.S. Cl. CPC G06T 17/20; G06F 3/04815; G06F 3/04845; G06F 3/04883
USPC 345/427

(57) ABSTRACT

Provided is a method for virtual visualization of a three-dimensional (3D) model of an object in a two-dimensional (2D) environment. The method may include receiving an import request to import a 2D environment to be used as a background for the 3D model; importing, based on the import request, the 2D environment; receiving wireframe data to define a perspective of the 2D environment; receiving scale data to define a scale of the wireframe; visualizing, based on the wireframe data, the wireframe; receiving a superimposing request to superimpose the 3D model of the object onto the 2D environment based on the wireframe data and the scale data; and superimposing the 3D model of the object onto the 2D environment based on the superimposing request. The two-dimensional environment may include existing graphical materials or graphical materials captured as a still image or a live feed image.

### CROSS REFERENCE TO RELATED APPLICATIONS

This application claims the benefit of and priority as a continuation-in-part application to U.S. Non-Provisional patent application Ser. No. 13/552,658 entitled “VISUALIZATION OF THREE-DIMENSIONAL MODELS OF OBJECTS IN TWO-DIMENSIONAL ENVIRONMENT,” filed on 19 Jul. 2012, which is based on U.S. Provisional Patent Application No. 61/660,730 entitled “VISUALIZATION OF THREE-DIMENSIONAL MODELS OF OBJECTS IN TWO-DIMENSIONAL ENVIRONMENT,” filed on 17 Jun. 2012, the content of each of which is incorporated herein by reference for all purposes.

### FIELD

This application relates generally to data processing and, more specifically, to methods and systems for virtual visualization of three-dimensional (3D) models of objects in two-dimensional (2D) environments.

### BACKGROUND

3D visualization provides ample opportunities in various spheres of human life. Spatial representation of objects can help in comprehending and learning, designing and drafting, and accelerated decision making and planning. The ability to represent virtual 3D objects in a real environment can provide further applications, such as selecting furniture for a house, designing kitchen cabinets, and so forth. However, the complexity of present 3D visualization tools encumbers their usage for everyday tasks and limits their application. Therefore, it would be useful to have new systems with simplified processes of 3D visualization and the ability to use 2D images as a background for 3D models.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Provided are methods and systems for virtual visualization of a 3D model of an object in a 2D environment.

The method for virtual visualization of a 3D model of an object in a 2D environment may comprise receiving, from a user, an import request to import a 2D environment to be used as a background for the 3D model, and importing, based on the import request, the 2D environment. When the 2D environment is imported, the user may provide wireframe data to define a perspective of the 2D environment and scale data to define a scale of the wireframe. Based on the wireframe data, the wireframe may be visualized. After that, a superimposing request may be received from the user to superimpose the 3D model of the object onto the 2D environment, and, based on the superimposing request, the 3D model may be superimposed. While superimposing, the wireframe data and the scale data may be used to match the perspective and scale of the background.

In certain embodiments, the 2D environment may include a photo, a video recording, a camera feed, a drawing, or any other graphical material, whether existing or captured as a still image or a live feed image.

In certain embodiments, the 3D model may be connected to an online resource related to an object depicted by the 3D model. The online resource may include, for example, an online store that provides the object depicted by the 3D model for sale.

Thus, the present disclosure provides a useful tool for visualization of a 3D model in a 2D environment. In further exemplary embodiments, modules, subsystems, or devices can be adapted to perform the recited steps. Other features and exemplary embodiments are described below.

### BRIEF DESCRIPTION OF THE DRAWINGS

Embodiments are illustrated by way of example and not limitation in the figures of the accompanying drawings, in which like references indicate similar elements and in which:

FIG. 1 is a block diagram illustrating an example of the overall system for virtual visualization of 3D models of objects in a 2D environment, in accordance with various embodiments.

FIG. 2 is a block diagram showing various modules of the computer system for virtual visualization of 3D models of objects in a 2D environment, in accordance with certain embodiments.

FIG. 3 is a flow chart illustrating a method for virtual visualization of 3D models of objects in a 2D environment, in accordance with certain embodiments.

FIG. 4 is a schematic representation of a sample 2D environment, in accordance with certain embodiments.

FIG. 5 is a schematic representation of a sample 2D environment with a wireframe that defines the geometry of 3D space and a scale that is used to assign dimension to a 3D model, in accordance with certain embodiments.

FIG. 6A is a schematic representation of a sample 2D environment with a 3D model superimposed onto the 2D environment based on a defined wireframe and scale, in accordance with certain embodiments.

FIG. 6B is a method flowchart detailing steps for social sharing of a sample of 2D environment with a 3D model superimposed onto the 2D environment, in accordance with certain embodiments.

FIG. 7 illustrates an example of a computer system, in which various embodiments may be implemented.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

Systems and methods described herein may allow a user to visualize 3D models of objects in relation to a real environment represented by a 2D photo or video.

A user may import his images, video records, or other graphics to a system for virtual visualization of 3D models of objects in a 2D environment and use these images, video records, or other graphics as a background for a 3D object. The imported image will represent a 2D environment. To insert a 3D object into such environment, the user may define a 3D space that mimics the perspective of the background, and determine a scale for the defined 3D space. After that, the user may insert a 3D model of an object in such a way that the 3D model matches the perspective and scale of the background. The user may move and spin the 3D model in the 2D environment to choose an appropriate position for the object within the background. A resulting image, being the combination of the 2D environment and the 3D model over it, may represent a virtual object of the 3D model as fitted in the real environment captured on a photo or video.

The user may save the resulting image to a Personal Computer (PC) or network database for future use or reference, post the resulting image on a social network, and perform other operations on the image. The user may also use saved images to compare them with each other and with newly obtained images in order to select preferable combinations of a 2D background and 3D object.

In some embodiments, the system for virtual visualization of 3D models of objects in a 2D environment may be connected to various social networking services and/or microblogs, for example, Facebook™, Twitter™, Pinterest™ and such others. Connection to social networking services and/or microblogs may allow users to interact with each other in relation to images obtained using the system for virtual visualization of 3D models of objects in a 2D environment, receive advice from friends and/or subscribers when choosing some goods or products virtually, and share information and images depicting 3D objects in 2D environment. For example, a user may post an image depicting a 3D object in 2D environment to receive feedback from his friends and/or subscribers when choosing such goods as furniture, clothes, and jewelry; creating interior and/or landscape designs; and so forth.

Images, video records, or other graphics, to be used as a background, may comprise existing photos, video records, and so forth. Furthermore, a live camera feed may be used when captured before importing a 2D environment or in the process of virtual visualization. The option of capturing a photo or video to be used as a 2D environment may be especially useful when the system is implemented as a mobile application. In this case, a user may use mobile phone means, such as a camera, to capture photos or record video.

In some embodiments, the system for virtual visualization of 3D models of objects in a 2D environment may include a library of pre-configured background images with wireframes to facilitate matching the imported real backgrounds and 3D models.

The system for virtual visualization of 3D models of objects in a 2D environment may include or be coupled to a library of 3D models of objects. A user may select 3D models to be inserted into an imported 2D environment from 3D models available in the library, or he may import or create his own 3D models.

In some embodiments, the library of 3D models of objects may include pre-configured background images with wireframes to facilitate matching 2D backgrounds and 3D models of objects.

In some embodiments, a user may connect a 3D model of an object to an online store where other users could purchase the item depicted by the 3D model. Alternatively, a connection to an online store for purchasing the depicted object may be pre-embedded in the 3D model stored in the library of 3D models.

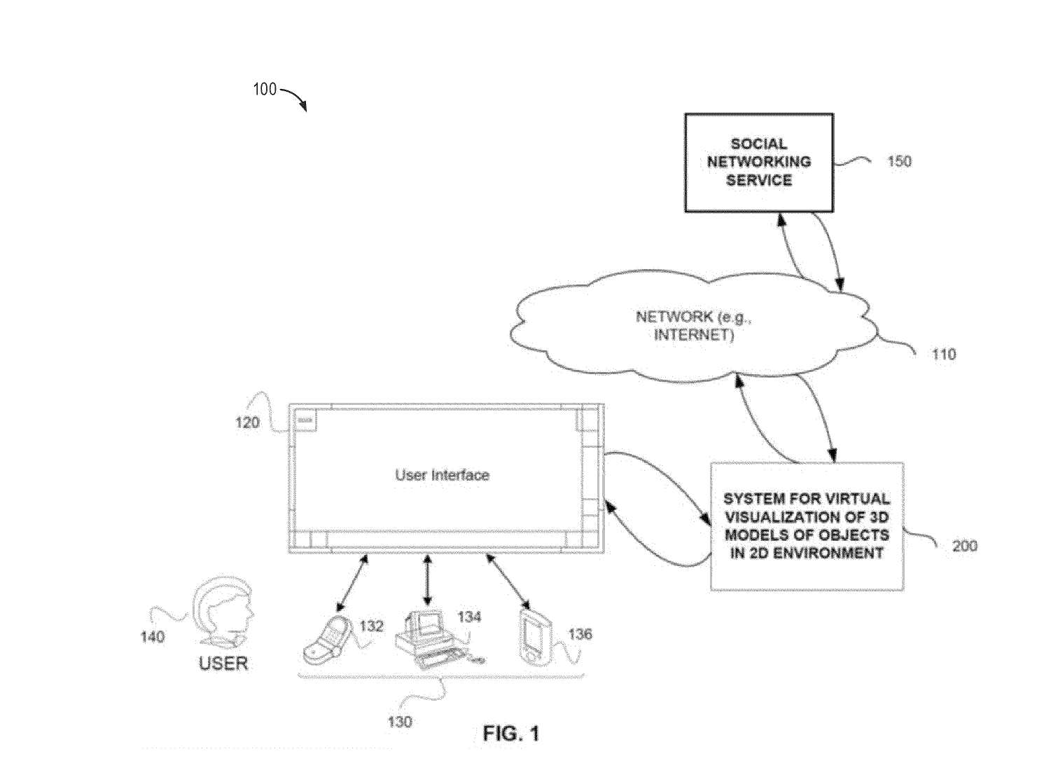

Referring now to the figures, FIG. 1 is a block diagram illustrating an example of the overall system for virtual visualization of 3D models of objects in a 2D environment, in accordance with various embodiments. FIG. 1 shows an architecture 100 that may include a network 110, client devices 130, a user 140, a user interface 120, a social networking service 150, and a system for virtual visualization of 3D models of objects in 2D environment 200. The network 110 may include the Internet or any other network capable of communicating data between devices. Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 110 may further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking. The network 110 may be a network of data processing nodes that are interconnected for the purpose of data communication.

The client devices 130, in some example embodiments, may include a Graphical User Interface (GUI) for displaying the user interface 120. In a typical GUI, instead of offering only text menus or requiring typed commands, the system presents graphical icons, visual indicators, or special graphical elements called widgets that may be utilized to allow the user 140 to interact with the user interface 120. The client devices 130 may be configured to utilize icons used in conjunction with text, labels, or text navigation to fully represent the information and actions available to users.

The client devices 130 may include a mobile telephone 132, a computer 134, a personal digital assistant (PDA) 136, and the like. The user 140, in some example embodiments, is a person interacting with the user interface 120 via the client devices 130. The system for virtual visualization of 3D models of objects in 2D environment 200 may be implemented as a local or web service on the client devices 130. The user 140 may periodically interact with the system for virtual visualization of 3D models of objects in 2D environment 200 via the user interface 120 displayed using one of the client devices 130. Additionally, the user 140 may periodically interact with the social networking service 150 (including social networks, microblogs, web blogs, and other web resources) via the system for virtual visualization of 3D models of objects in 2D environment 200 and the network 110 to upload graphics obtained using the system for virtual visualization of 3D models of objects in 2D environment 200, communicate with members of the social networking service 150, and so forth.

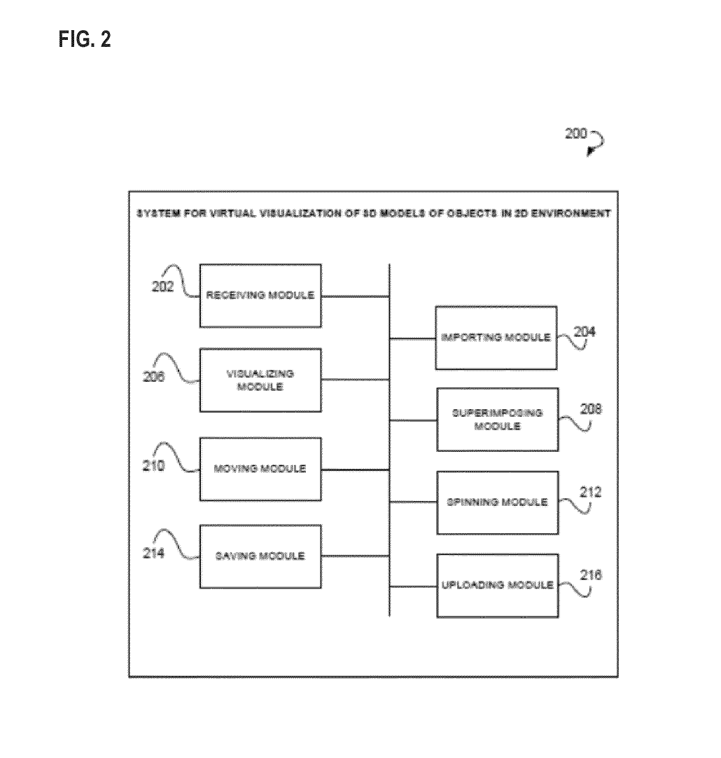

FIG. 2 illustrates a detailed block diagram of the system for virtual visualization of 3D models of objects in 2D environment 200, in accordance with an example embodiment. The system for virtual visualization of 3D models of objects in 2D environment 200 may include a receiving module 202, an importing module 204, a visualizing module 206, a superimposing module 208, a moving module 210, a spinning module 212, a saving module 214, and an uploading module 216.

Note that even though various modules of the system for visualization of 3D models of objects in 2D environment 200 are shown together, the system for visualization of 3D models of objects in 2D environment 200 may be implemented as a web service, via a distributed architecture, or within a cloud computing environment.

The receiving module 202 of the system for visualization of 3D models of objects in 2D environment 200 may be configured to receive import requests, wireframe data, scale data, and superimposing requests from a user. Based on import requests, which may include user-specified data on a 2D environment to be used as a background for a 3D model, the importing module 204 may import the 2D environment. Then, the receiving module 202 may receive wireframe data (which define a perspective of the 2D environment) and scale data (which define a scale of the 2D environment) from the user. The wireframe data and scale data may be used by the visualizing module 206 to visualize the wireframe over the imported 2D environment. The wireframe is an auxiliary element and may be hidden at any moment based on a user request.

Then, the receiving module 202 may receive a superimposing request from the user. The superimposing request may include data on a 3D model the user selected in a library of 3D models or from 3D models imported or saved by the user, customization or changes to the selected 3D model, and so forth. The received superimposing request is passed to the superimposing module 208, which superimposes the selected 3D model (based on the superimposing request) onto the 2D environment. At that, the wireframe may be used to fit the 3D model into the 2D environment in accordance with the perspective and scale of the 2D environment.

The superimposed 3D model may be moved by the moving module 210 and spun by the spinning module 212 within the 2D environment.

When the appropriate place and spin of the 3D model are selected, the resulting image may be uploaded to a social network, microblogging service, blog, or any other web resource by the uploading module 216. Additionally, based on a user request, the saving module 214 may save the resulting image for future use or reference.

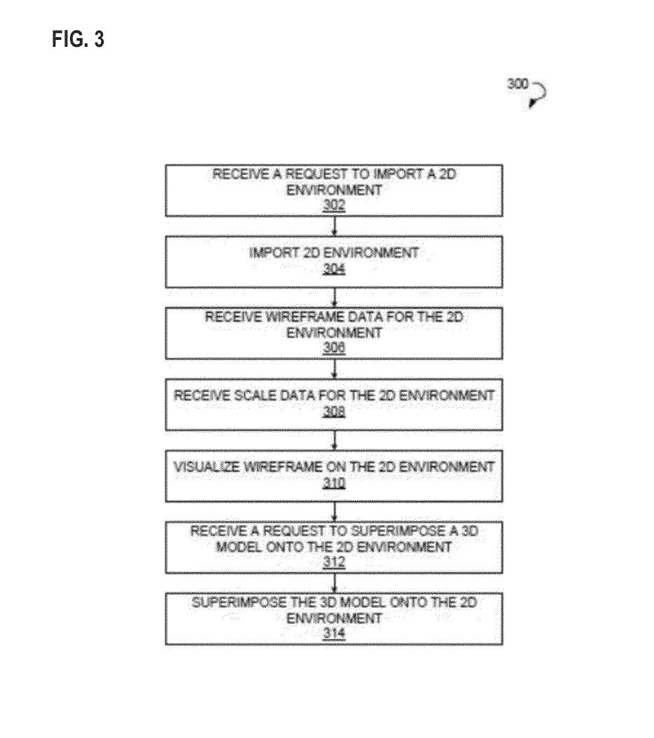

FIG. 3 shows a flow chart of a method 300 for virtual visualization of 3D models of objects in a 2D environment, in accordance with an example embodiment. The method 300 may be performed by processing logic that may comprise hardware (e.g., dedicated logic, programmable logic, microcode, etc.), software (such as computer code executable on a general-purpose computer system or a specifically configured computer system), or a combination of both. In one example embodiment, the processing logic resides at the system for virtual visualization of 3D models of objects in 2D environment 200, illustrated in FIG. 2. The method 300 may be performed by the various modules discussed above with reference to FIG. 2. Each of these modules may comprise processing logic.

As shown in FIG. 3, the method 300 may commence at operation 302, with the receiving module 202 receiving an import request to import a 2D environment. A 2D environment comprises a background for a 3D model of an object. A 2D environment may include an image, a video recording, a live camera feed, a drawing, a graphic, or any other graphics. At operation 304, the 2D environment is imported according to the import request. Then, the receiving module 202 may receive, from the user, wireframe data at operation 306 and scale data at operation 308. The wireframe data may provide information necessary for the creation of a 3D model space that corresponds to the perspective shown in the image. The 3D model space would have a defined and fixed perspective and also user-defined spatial dimensions (scale). The 3D model space would provide a framework for insertion of a 3D object or model that would be viewed in a perspective mimicking the perspective of the 2D environment.

Based on the received wireframe and scale data, the visualizing module 206 may visualize the wireframe in front of the 2D environment at operation 310.

Then, at operation 312, the receiving module may receive a request to superimpose a 3D model onto the 2D environment. A superimposing request may include data on a user selection of a 3D model from a library of 3D models (embedded in or coupled to the system for virtual visualization of 3D models of objects in 2D environment 200), from 3D models saved or imported by the user, or from any online resource. Additionally, a superimposing request may include data on customization or changes to the selected model. At operation 314, the selected 3D model may be superimposed onto the 2D environment. Due to the wireframe created for the 2D environment, the 3D model may be superimposed in accurate relation (perspective and scale) to the 2D environment set as a background. The superimposed 3D model may be moved and spun to adjust its position within the background.

In some embodiments, the 3D object that is inserted in front of the 2D background image can be linked or connected to a manufacturer or a sales representative of the object represented by the 3D model. Upon following such link, a user would be provided with an option of purchasing the actual item.

Additionally, the resulting image, obtained after superimposing a 3D model onto the 2D background image, may be saved for future use or reference, or uploaded to a web resource specified by the user (for example, a social network, a microblog, an online store). The user may also use saved images to compare them with each other and with newly obtained images in order to select preferable combinations of a 2D background and 3D object.

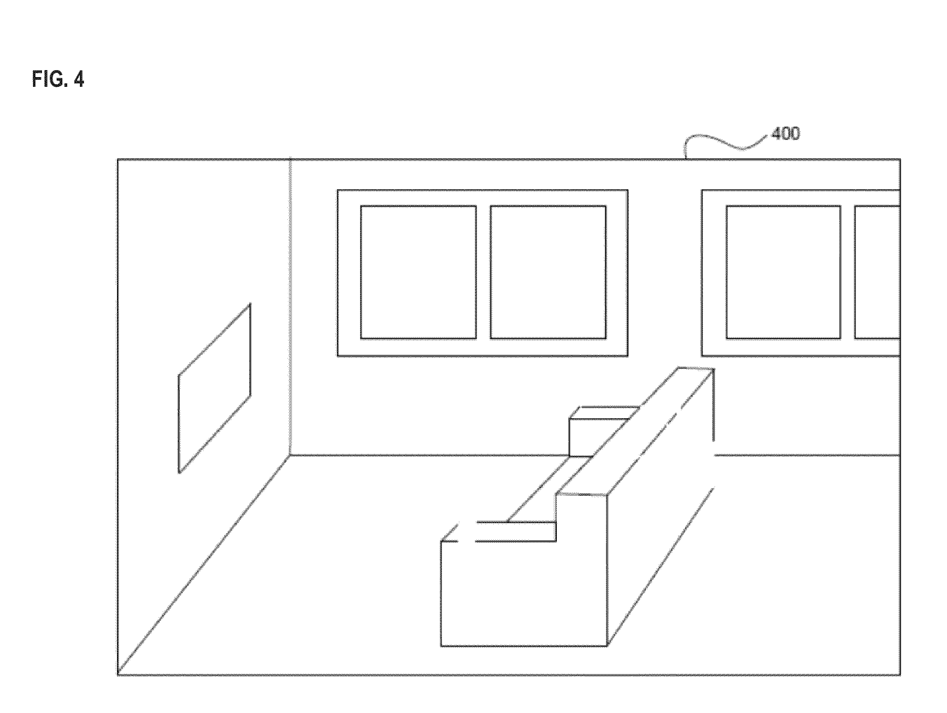

FIG. 4 is a schematic representation of a sample 2D environment 400, in accordance with certain embodiments. The sample 2D environment 400 may be a background for a 3D model of an object in order to visualize a virtual 3D object in a real environment. The sample 2D environment 400 may include any digital image (a photo, any graphic file, a live camera feed, and so forth) whether captured by a user or downloaded from a special library coupled to the system for virtual visualization of 3D models of objects in 2D environment 200, online resource, and the like.

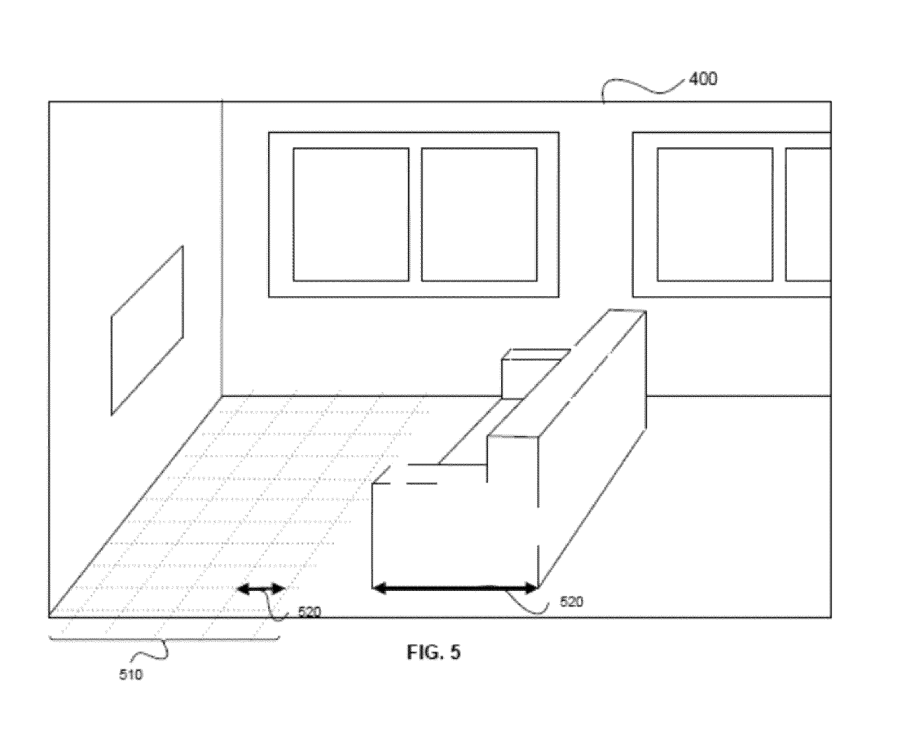

FIG. 5 represents the sample 2D environment 400 with a wireframe 510 that defines the geometry of a 3D space and a scale 520 that is used to assign dimensions to a 3D model. To provide an environment that will allow inserting a 3D model, the user may assign a 3D model space in the form of the wireframe 510 that will match the perspective of the background. Defining the wireframe 510 may have many different physical manifestations. It could be a wireframe box that may be adjusted, or the user may use a mouse or a finger (on a device with a sensor screen) to generate lines or points that will describe the perspective of the background image.

Once the wireframe 510 is assigned, the user may add a scale 520 to the 3D model space of the wireframe 510. For this purpose, the user may select a single length of a part of the background, or assign a length to a single known distance. This will help to assign a scale 520 to the model space. The way a user assigns a scale 520 to the 3D model space could have a different look and feel. The user could generate a solid line or the line could be present and moved into place.

The wireframe 510 may be hidden, so that the user could view the image in its real state.

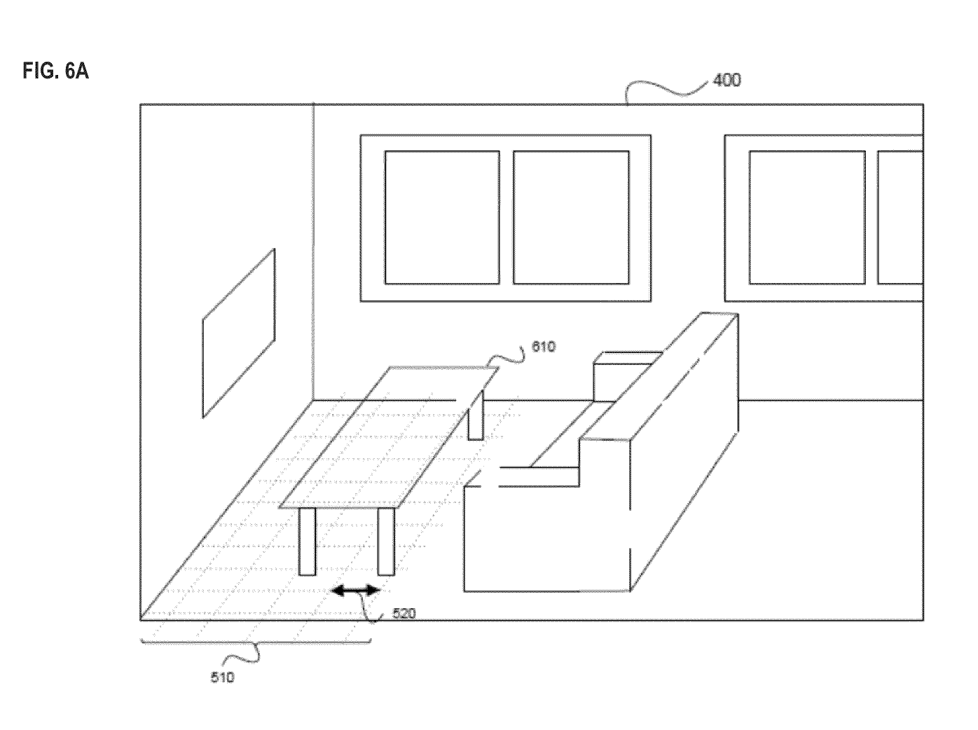

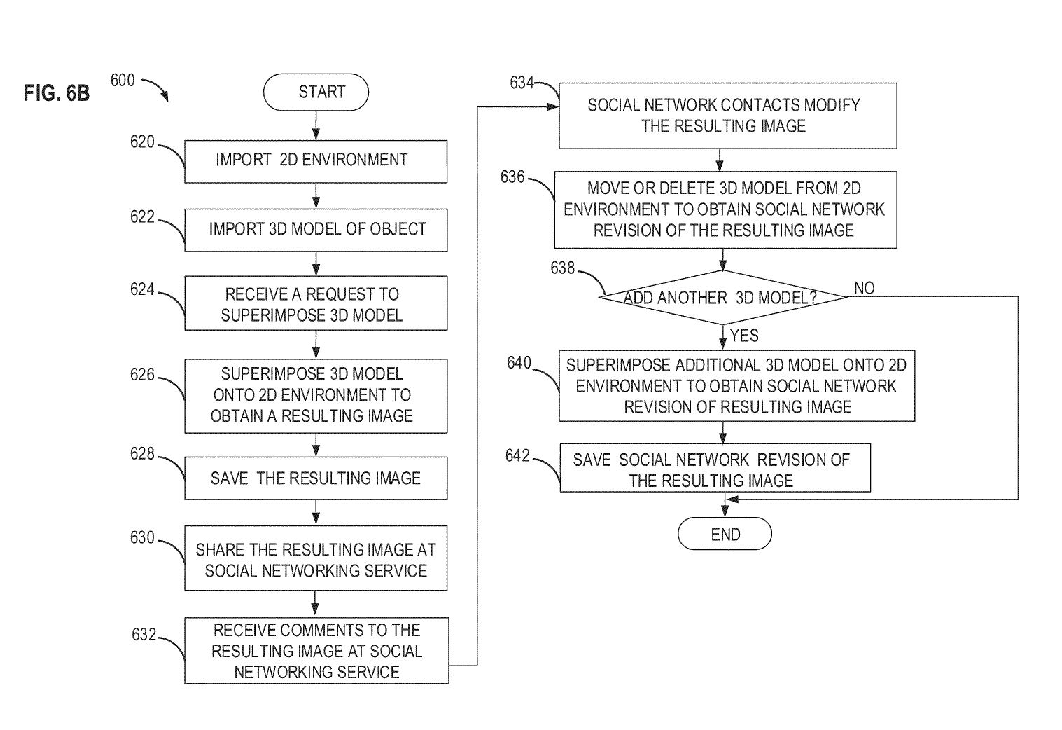

FIG. 6A represents a 3D model 610 inserted into the sample 2D environment 400 based on the wireframe 510 and scale 520 defined by the user. After the user defines the wireframe 510 and scale 520, he may select the 3D model 610 he wants to view in the sample 2D environment 400. The user may select the 3D model 610 from a library of 3D object models, which contains pre-configured 3D object models. The library of 3D object models may be embedded in or coupled to the system for virtual visualization of 3D models of objects in 2D environment 200. Alternatively, the user may use any other online resources to select and download 3D models, or he may create his own 3D models and/or import 3D models from the network 110.

When the 3D model 610 is selected, it may be uploaded to the sample 2D environment 400. The uploaded 3D model 610 will have a scale and perspective that matches the background condition. Due to this, the user may view how the object depicted by the 3D model would fit into the background.

Once the 3D model 610 is inserted into the background, the user may move and spin the 3D model 610 in order to place it in different relation to the background.

In some embodiments, the user may switch between multiple 3D models on the same background to compare them and choose the 3D models that best fit the environment. For example, 3D models may represent furniture or home decorations for interior designs creation; lawn furniture, plants, or garden ornaments for creating landscape designs; designer clothes, jewelry, or make-up for image making, and so forth.

The resulting image, comprising the sample 2D environment 400 and the 3D model 610, may be saved and used, for example, to compare with other images or shared on social networks for peer comments.

In some embodiments, the 3D model 610 of an object may be connected to an online store, where a user could purchase the item depicted by the 3D model 610. Additionally, the user may create new 3D models to be used by the system for virtual visualization of 3D models of objects in 2D environment 200. These 3D models may be uploaded to the library of 3D object models or any other resource to be used/purchased by the system for virtual visualization of 3D models of objects in 2D environment 200 and/or other users.

FIG. 6B illustrates an example flowchart of a method 600 for social sharing of the resulting image obtained by the user by superimposing 3D models of objects in a 2D environment. The method 600 may be performed by processing logic that may comprise hardware, software, or a combination of both. In some embodiments, the processing logic may reside at the system for virtual visualization of 3D models of objects in 2D environment, as illustrated in FIG. 2. For example, each of these modules may comprise processing logic. The method 600 may be performed by the various modules discussed with reference to FIG. 2.

As shown in FIG. 6B, method 600 may begin at operation 620, the receiving module 202 receiving a request to import a 2D environment. The 2D environment may include a photo or an image of a room, such as a living room or a study room, or an office space, and the like. Additionally, the 2D environment may include a video recording, or a live camera feed, or any other graphics.

At operation 622, the receiving module 202 may further receive an import request to import a 3D model of an object. The user may select 3D models of objects from the library of 3D models of objects. The library of 3D models may be embedded in or coupled to the system for virtual visualization of 3D models of objects in 2D environment 200. Alternatively, the user may use online resources to select and download 3D models, and/or import 3D models from the network 110. The 2D environment described above may further provide the background for superimposing the 3D model.

At operation 624, the receiving module 202 may receive a request from the user to superimpose a 3D model onto the 2D environment. Following the superimposing request, at operation 626, the 3D model may be superimposed in precise relation to the 2D environment set as the background, to obtain the resulting image.

The method 600 continues at operation 628, with the saving module 214 receiving a save request to save or store the resulting image.

At operation 630, the user may upload the resulting image to socially share the resulting image at social networking service 150. In some embodiments, the social networking service 150 may include social networking services and web blogs, such as Pinterest™, Flickr™, Google+™, Facebook™, Twitter™ and other similar services.

Social sharing may allow social network contacts of the user, such as friends and family members of the user to visualize and share their opinion about the resulting image on the social networking services. Additionally, social network contacts of the user may include interior designers or architects or paid space decorating experts and such others, who may socially share their views or modifications for the resulting image.

The method 600 continues to operation 632, where the resulting image shared at the social network services may receive comments. Social networking services, may provide features allowing social network contacts of the user to express opinions, such as approval or disapproval of the resulting images. For example, on Facebook™, approval takes the form of a “Like” button; on Google+™, approval takes the form of a “+1” button; on Twitter™ approval takes the form of “Follow” button, and so forth.

Additionally, social network contacts of the user may provide a comment to the resulting images. The comment may include an approval statement, an affinity statement, a disapproval statement, an image data, a picture data, a video data, and such others. For example, the user may decide to add a chair to a study room. Contacts of the user, such as the user's sister, may suggest a different type of chair for the study room. In this example, the user's sister may comment on the resulting image by providing a photograph, providing name of the manufacturer for the chair she has in mind, inserting a different 3D model of a preferred chair, or suggesting a blog link where similar chairs may be viewed. Further, the user may invite and engage multiple parties at the social networking service to provide comments, either in written form or in the form of a modification or revision of the resulting image to create a social network revision of the resulting image.

As part of and/or in addition to providing comments, as shown at operation 634, social network contacts of the user may modify the resulting image. The social network contacts of the user may download the resulting image, modify the 3D model of the object in the 2D environment to obtain a social network revision of the resulting image and share the social network revision of the resulting image on the social network services. Modifying the 3D model may include moving or deleting the 3D model superimposed onto the 2D environment. Modifying the 3D model may also include changing color or material of the 3D model. The moving module 210 may receive a request to move the 3D model superimposed onto the 2D environment.

As indicated at operation 636, social network contacts of the user may as part of adding comments, or in addition to the comments, move or delete 3D models from the 2D environment to obtain the social network revision of the resulting image. For example, the user may add a wall painting to a living space. A social network contact of the user at the social networking service, such an interior designer, may move the wall painting to a different position within the living space, providing the social network revision of the resulting image. In another example, a social network contact of the user, such as the user's work colleague, may remove the wall painting from the living space, proving another social network revision of the resulting image.

In some embodiments, social network contacts as part of the comments or in addition to the comments may further add 3D models of objects to the resulting image, providing social network revision of the resulting image. As shown in the method 600, at operation 638, social network contacts of the user may decide to add another 3D model to the 2D environment. For example, the user may share a resulting image of a table in a living room at the social network service. A social network contact of the user, such as the user's mother, may add a selected couch next to the table in the living room, thereby providing further social network revision to the resulting image. Another social network contact may then add a further comment, such as replacement of the couch with a different couch, such that a second social network revision is applied to the resulting image.

As described in more detail above, in operation 640, the receiving module 202 may receive a request to superimpose additional 3D models onto the 2D environment. The received superimposing request is passed on to the superimposing module 208, which superimposes the selected 3D model onto the 2D environment and a social network revision of the resulting image is obtained.

At operation 642, the saving module 214 may receive a saving request to save the social network revision of the resulting image. The social network revisions may be accessible by the user at various levels such that a user may select and view a first revision, a second revision, a final revision, etc.

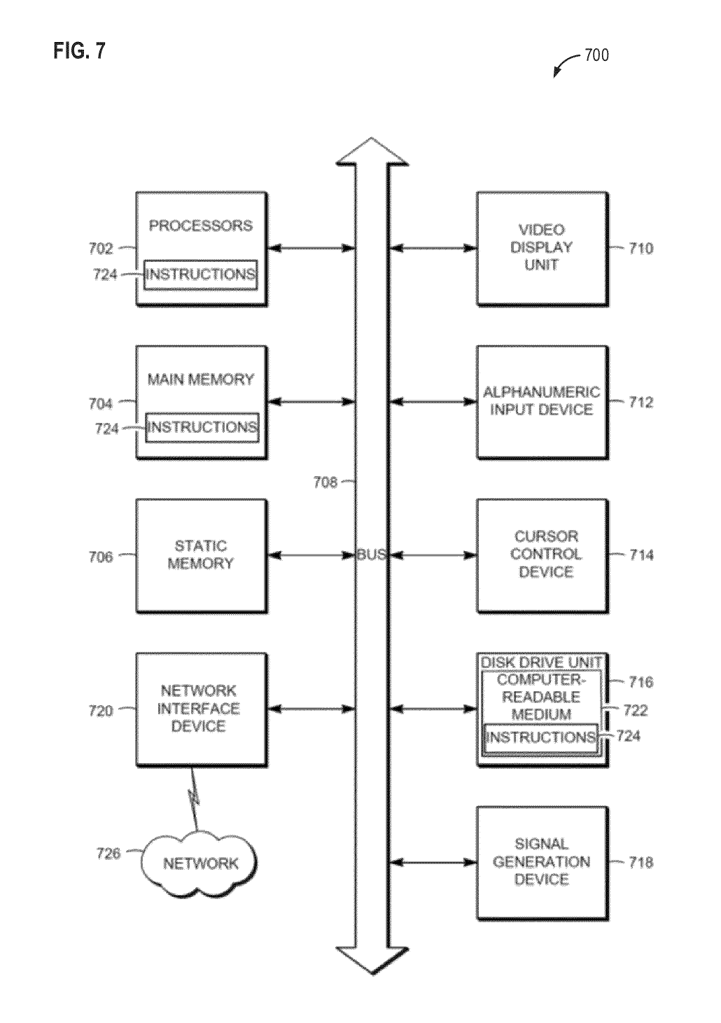

FIG. 7 shows a diagrammatic representation of a machine in the example electronic form of a computer system 700, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a PC, a tablet PC, a set-top box (STB), a PDA, a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor or multiple processors 702 (e.g., a central processing unit (CPU), a graphics processing unit (GPU), or both), a main memory 704 and a static memory 706, which communicate with each other via a bus 708. The computer system 700 may further include a video display unit 710 (e.g., a liquid crystal display (LCD) or a cathode ray tube (CRT)). The computer system 700 may also include an alphanumeric input device 712 (e.g., a keyboard), a cursor control device 714 (e.g., a mouse), a disk drive unit 716, a signal generation device 718 (e.g., a speaker), and a network interface device 720.

The disk drive unit 716 includes a computer-readable medium 722, on which is stored one or more sets of instructions and data structures (e.g., instructions 724) embodying or utilized by any one or more of the methodologies or functions described herein. The instructions 724 may also reside, completely or at least partially, within the main memory 704 and/or within the processors 702 during execution thereof by the computer system 700. The main memory 704 and the processors 702 may also constitute machine-readable media.

The instructions 724 may further be transmitted or received over a network 726 via the network interface device 720 utilizing any one of a number of well-known transfer protocols (e.g., Hyper Text Transfer Protocol (HTTP)).

While the computer-readable medium 722 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like.

The example embodiments described herein may be implemented in an operating environment comprising software installed on a computer, in hardware, or in a combination of software and hardware.

Thus, a system and method for virtual visualization of 3D models of objects in 2D environment have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

1. A method for virtual visualization of a three-dimensional model of an object in a two-dimensional environment, the method comprising:
receiving, from a user, an import request to import the two-dimensional environment to be used as a background for the three-dimensional model;
importing, based on the import request, the two-dimensional environment;
receiving, from the user using a mouse or a finger to generate lines or points, wireframe data to define a three-dimensional model space in the form of a wireframe that corresponds to a perspective of the two-dimensional environment, the three dimensional model space being used for insertion of the three-dimensional model of the object to be viewed in a perspective associated with the two-dimensional environment;
receiving, from the user, scale data of a single length of a part of the two-dimensional environment to define a scale of the wireframe;
visualizing, based on the wireframe data, the wireframe on the two-dimensional environment;
receiving, from the user, a superimposing request to superimpose the three-dimensional model of the object onto the two-dimensional environment based on the wireframe data and the scale data;
superimposing the three-dimensional model of the object in accurate relation onto the two-dimensional environment based on the superimposing request;
receiving, from the user, an uploading request to upload a resulting image to a social networking service, the resulting image being the three-dimensional model superimposed onto the two-dimensional environment;
uploading, based on the uploading request, the resulting image;
receiving, from the social networking service, a social network revision of the resulting image; and
saving, based on a saving request, the social network revision of the resulting image.

2. The method of claim 1, wherein the two-dimensional environment is selected from a library of pre-configured background images with wireframes to facilitate matching the imported two-dimensional environment and the three-dimensional model.

3. The method of claim 1, wherein the two-dimensional environment includes existing graphical materials or graphical materials captured as a still image or a live feed image.

4. The method of claim 1, wherein the user selects the three-dimensional model from a library of three-dimensional models.

5. The method of claim 1, wherein the user creates one or more of the three-dimensional models or imports one or more of the three-dimensional models.

6. The method of claim 1, wherein the user switches between one or more of the three-dimensional models superimposed onto the two-dimensional environment.

7. The method of claim 1, wherein the user moves and spins the three-dimensional model superimposed onto the two-dimensional environment.

8. The method of claim 1, further comprising:
receiving, from the user, a saving request to save a resulting image, the resulting image being the three-dimensional model superimposed onto the two-dimensional environment;
saving, based on the saving request, the resulting image.

9. A system for virtual visualization of a three-dimensional model of an object in a two-dimensional environment, the system comprising:
a receiving module configured to receive import requests, wireframe data using a mouse or a finger to generate lines or points, scale data of a single length of a part of the two-dimensional environment, superimposing requests from a user and social network contact of the user, and wireframe data to define a three-dimensional model space in the form of a wireframe that corresponds to a perspective of the two-dimensional environment, the three dimensional model space being used for insertion of the three-dimensional model of the object to be viewed in a perspective associated with the two-dimensional environment;
an importing module configured to import, based on the import requests of the user, the two-dimensional environment;
a visualizing module configured to visualize a wireframe on the two-dimensional environment, based on the wireframe data and the scale data, to define a perspective of the two-dimensional environment;
a superimposing module configured to superimpose, based on the superimposing requests, the three-dimensional model of the object in accurate relation onto the two-dimensional environment based on the wireframe data and the scale data; and
a saving module configured to save, based on a saving request from the user, a resulting image, the resulting image being the three-dimensional model superimposed onto the two-dimensional environment, and a social network revision of the resulting image.

10. The system of claim 9, wherein the two-dimensional environment is selected from a library of pre-configured background images with wireframes to facilitate matching the imported two-dimensional environment and the three-dimensional model.

11. The system of claim 9, wherein the two-dimensional environment includes existing graphical materials or graphical materials captured as a still image or a live feed image.

12. The system of claim 9, wherein the user selects the three-dimensional model from a library of three-dimensional models.

13. The system of claim 9, wherein the user creates one or more of the three-dimensional models or imports one or more of the three-dimensional models.

14. The system of claim 9, further comprising:
a moving module configured to move the three-dimensional model superimposed onto the two-dimensional environment;
a spinning module configured to spin the three-dimensional model superimposed onto the two-dimensional environment.

15. The system of claim 9, further comprising:
an uploading module configured to upload, based on an uploading request of the user, a resulting image, the resulting image being the three-dimensional model superimposed onto the two-dimensional environment.

16. A non-transitory computer-readable medium comprising:
instructions, which when executed by one or more processors, perform the following operations:
receive, from a user, an import request to import a two dimensional environment to be used as a background for a three-dimensional model;
import, based on the import request, the two-dimensional environment;
received, from the user using a mouse or a finger to generate lines or points, wireframe data to define a three-dimensional model space in the form of a wireframe that corresponds to a perspective of the two-dimensional environment, the three-dimensional model space being used for insertion of the three-dimensional model of the object to be viewed in a perspective associated with the two-dimensional environment;
visualize, based on the wireframe data, the wireframe on the two-dimensional environment;
receive, from the user, scale data of a single length of a part of the two-dimensional environment to define a scale of the two-dimensional environment;
receive, from the user, a superimposing request to superimpose the three-dimensional model of the object onto the two-dimensional environment based on the wireframe data and the scale data; and
superimpose the three-dimensional model of the object in accurate relation onto the two-dimensional environment based on the superimposing request.
receive, from the user, an import request to import a social network revision of the resulting image; and
import, based on the import request, the social network revision of the resulting image.

17. The method of claim 1, wherein the three-dimensional model is connected to an online resource related to the object depicted be the three-dimensional model.

18. The system of claim 9, wherein the three-dimensional model is connected to an online resource related to the object depicted by the three-dimensional model.

19. The method of claim 1, further comprising;
modifying the three-dimensional model, wherein modifying includes moving or deleting the three-dimensional model superimposed onto the two-dimensional environment, based on the social network revision of the resulting image.

20. The method of claim 1, further comprising;
modifying the resulting image, wherein modifying includes inserting an additional three-dimensional model of an object onto the two-dimensional environment, based on the social network revision of the resulting image.
